(19) United States
(12) Patent Application Publication
(10) Pub. No.: US 2013/0173279 A1
(43) Pub. Date: Jul. 4, 2013

(54) METHOD AND SYSTEM FOR PROVIDING DERMATOLOGIC TREATMENT

(71) Applicants: Michael C. Pope, San Jose, CA (US); Christopher P. Schmidt, San Jose, CA (US)

(72) Inventors: Michael C. Pope, San Jose, CA (US); Christopher P. Schmidt, San Jose, CA (US)

(21) Appl. No.: 13/450,725

(22) Filed: Apr. 19, 2012

Related U.S. Application Data
(60) Provisional application No. 61/581,296, filed on Dec. 29, 2011.

(51) Int. Cl. G06Q 50/22; G06Q 30/02; G06Q 40/08

(52) U.S. Cl. 705/2

(57) ABSTRACT

Method for providing dermatologic treatment wherein an electronic request for treatment is received by a physician. The electronic request is associated with an image of a patient's skin. The physician may choose a diagnosis from sets of diagnoses which are grouped according to types of skin conditions. The physician is then provided with a set of treatment options, at least one of which comprises a medication as an advertisement.

### RELATED U.S. APPLICATION

This application claims priority to the copending provisional patent application, Ser. No. 61/581,296, Attorney Docket Number IDN-001.PRO, entitled “METHOD AND SYSTEM FOR PROVIDING DERMATOLOGIC TREATMENT,” with filing date Dec. 29, 2011, hereby incorporated by reference in its entirety.

### BACKGROUND

Dermatologists specialize in the diagnosis and treatment of skin related medical issues. Due to the relatively low number of dermatologists, there is often a shortage of dermatology access. This is especially true in lower-populated areas.

### BRIEF DESCRIPTION OF THE DRAWINGS

The accompanying drawings, which are incorporated in and form a part of this application, illustrate embodiments of the subject matter, and together with the description of embodiments, serve to explain the principles of the embodiments of the subject matter. Unless noted, the drawings referred to in this brief description of drawings should be understood as not being drawn to scale.

FIG. 1 illustrates an example tele-dermatology interaction environment, in accordance with an embodiment.

FIGS. 2A-2B illustrate an example tele-dermatology system, in accordance with various embodiments.

FIG. 3 is screen-shot of a web-service with drop down menus which allow a dermatologist to select a group of diagnoses, a diagnosis, and a treatment option in accordance with an embodiment.

FIG. 4 is a screen-shot of a web-service with text boxes for a dermatologist to take notes about a seeking entity and send messages to a seeking entity, in accordance with an embodiment.

FIG. 5 is a block diagram of an exemplary computer system used in accordance with one embodiment of the present invention.

FIGS. 6A-6J illustrate a flow diagram of an example method of providing dermatologic treatment, in accordance with various embodiments.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope as defined by the appended claims. In some embodiments, all or portions of the electronic computing devices, units, and components described herein are implemented in hardware, a combination of hardware and firmware, a combination of hardware and computer-executable instructions, or the like. Such computer-executable instruction may be stored in tangible computer-readable storage media which may be fixed to or removable from the hardware of a computer system. Some examples of such tangible computer-readable storage media include, but are not limited to, silicon based memory, solid state or disk-based storage drives, and/or an optical storage disk. Furthermore, in the following description, numerous specific details are set forth in order to provide a thorough understanding of the subject matter. However, some embodiments may be practiced without these specific details. In other instances, well-known methods, procedures, objects, and circuits have not been described in detail as not to unnecessarily obscure aspects of the subject matter.

### Notation and Nomenclature

Unless specifically stated otherwise as apparent from the following discussions, it is appreciated that throughout the present Description of Embodiments, discussions utilizing terms such as “receiving,” “sending,” “presenting,” “generating,” “determining,” “notifying,” “customizing,” “accepting,” “permitting,” “providing,” “including,” or the like, refer to the actions and processes of a computer system or similar electronic computing device (or portion thereof) such as, but not limited to: a processor, a display device, and/or an I/O device. The electronic computing device manipulates and transforms data represented as physical (electronic) quantities within the electronic computing device's processors, registers, and/or memories into other data similarly represented as physical quantities within the electronic computing device's memories, registers and/or other such information storage, processing, transmission, or/or display components of the electronic computing device or other electronic computing device(s).

### Overview of Discussion

Example techniques, devices, systems, and methods for diagnosing and treating dermatologic conditions are described herein. Discussion of a high level description electronic physician-patient interaction is then described. Discussion continues with a description of components of a tele-dermatology system which facilitates diagnosing and treating dermatologic conditions. Next, operation of a tele-dermatology system is described. Discussion continues with a description of how the tele-dermatology system creates groups of diagnoses for skin conditions, examples of various diagnoses, and examples of various treatment options. Medications and treatment options which include advertisements are then discussed. Discussion continues with an example computer system environment. Lastly, example methods of use are discussed.

### Electronic Physician-Patient Interaction

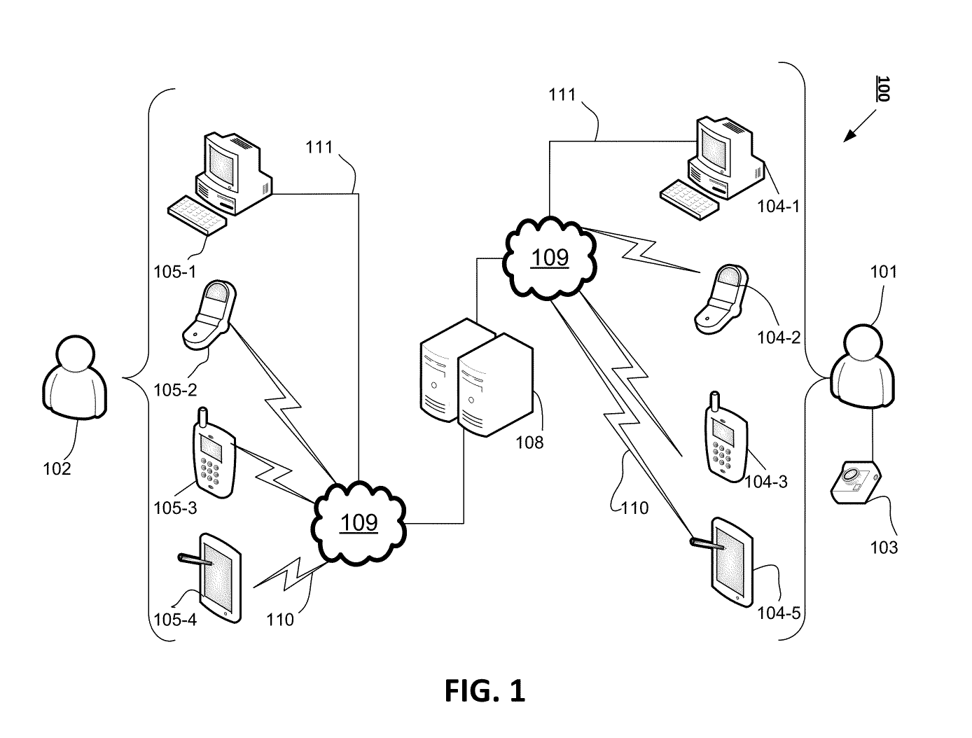

FIG. 1 is a block diagram of an example electronic physician-patient interaction system 100. Electronic physician-patient interaction system 100 is a networked environment for providing a seeking entity 101 with electronic access to dermatologic treatment from a providing entity 102. Utilizing electronic physician-patient interaction system 100, a seeking entity 101 may be anyone seeking advice from a dermatologist about a skin condition. It is to be understood that the seeking entity 101 may be a patient, a primary care physician, a health clinic, another dermatologist, and the like. It is to be understood that the terms patient and seeking entity are interchanged throughout the instant specification. The providing entity 102 may be a dermatologist or other specialized medical professional who is remotely matched with the seeking entity via electronic physician-patient interaction system 100. It is to be understood that the terms providing entity 102 may be interchanged throughout the instant specification with terms such as physician, dermatologist, or the like. In some embodiments, a web service may be used to facilitate interaction.

In one embodiment, tele-dermatology interaction environment 100 comprises: a seeking entity 101; a providing entity 102; a recording device 103; a seeking entity device 104; a providing entity device 105; a network 109; and a tele-dermatology system 108.

In one embodiment, a seeking entity 101 is a person or entity seeking treatment for a person (patient) with a skin condition. The seeking entity 101 may be a new client to the particular providing entity 102, or a return client. In some embodiments, the seeking entity 101 is the parent or relative of someone with a skin condition. For example, a seeking entity 101 mother may have one tele-dermatology account for her entire family. Similarly, a seeking entity 101 primary care physician may have one tele-dermatology account for a plurality of patients for which she seeks consulting opinions from a dermatologist via tele-dermatology system 108.

In one embodiment, a providing entity 102 is a physician licensed to provide medical care. For example, providing entity 102 is a dermatologist in some embodiments. In some embodiments, providing entity 102 is not a dermatologist, but instead a pediatrician, physician's assistant, nurse practitioner, general care practitioner, or other type of physician. Still in other embodiments, providing entity 102 is a hospital, emergency care clinic, or an insurance provider.

In one embodiment, recording device 103 is a camera used by a seeking entity 101 to capture images of a skin condition. In some embodiments, recording device 103 is a video and/or sound recorder. After procuring at least one image, video or recording with recording device 103, seeking entity 101 may send at least one image, video or recording to tele-dermatology system 108 along with a request for treatment. Further, in some embodiments recording device 103 may also be used to send at least one image, video or recording to tele-dermatology system 108, such as when recording device 103 is a smart phone 104-3 or computer with recording and transmitting capabilities.

In one embodiment, seeking entity devices 104 can be used to transmit and receive data to and from tele-dermatology system 108. Seeking entity devices 104 may include a computer 104-1, cellular telephone 104-2, smart phone 104-3, or a portable computer 104-5, or any device which has access to the internet. It is to be appreciated that this merely an example of possible transmitting and receiving devices. In some embodiments, seeking entity devices 104 may be used to take photos of a skin condition as well as send them to a providing entity. In other embodiments, seeking entity devices 104 may comprise applications specifically tailored for tele-dermatology. For instance, a seeking entity 101 may be able to download a tele-dermatology application from an online application store. Further, in some embodiments seeking entity devices 104 may perform parts of the physician-patient based interaction.

In one embodiment, providing entity devices 105 can be used to transmit and receive data to and from tele-dermatology system 108. Providing entity devices 105 may include a computer 105-1, cellular telephone 105-2, smart phone 105-3, or portable computer 105-5. It is to be appreciated that this is merely an example of possible transmitting and receiving devices. In other embodiments, providing entity devices may comprise applications specifically tailored for tele-dermatology.

In one embodiment, network 109 is a collection of hardware and software components and computers interconnected by communication channels that allow sharing of resources and information. In some embodiments, network 109 may be a wide area network or a local area network. In other embodiments, network 109 may be a implemented with a wireless connection 110 or a wired connection 111.

In some embodiments, the electronic physician-patient interaction may be entirely web based. In other embodiments, the electronic physician-patient interaction may be partially located on a seeking entity device 104 belonging to a seeking entity 101, seeking a diagnosis and/or treatment via system 100. In other embodiments, the electronic physician-patient interaction may be based and partially located on a providing entity device 105. In some embodiments electronic physician-patient interaction may be accomplished using a web service. A web service is a method of communication between two electronic devices over a network. Conventionally, a web service is a software system designed to support interoperable machine-to-machine interaction over a network. In some embodiments, a seeking entity and a providing entity are able to send messages via the web service. These messages may include text, audio, images, video, or other multimedia. In some embodiments messages may cover topics including, but not limited to: requests for treatment, notification of receipt, treatment options and options, or non-treatment related messages between a providing entity and a seeking entity.

After a message is sent to a providing entity (such as a dermatologist), the providing entity 102 may view the message by logging into his account. In some embodiments, the providing entity 102 will need to determine whether the image or images are of sufficient quality to perform a diagnosis. If the image or images are not, the providing entity 102 will notify the seeking entity 101. In other embodiments, the tele-dermatology system 108 will perform a quality analysis of the image or images. If an image is not of sufficient quality, the tele-dermatology system 108 will send a notification to the seeking entity 101, the providing entity 102, or both.

### Example Tele-Dermatology System

In one embodiment, tele-dermatology system 108 is a computer or group of computers with a program or programs running to serve the requests of other programs. The tele-dermatology system 108 performs computational tasks on behalf of the seeking entity 101 and the providing entity 102. In some embodiments, a web service may be hosted on tele-dermatology system 108. In other embodiments, a web service is hosted partially on a seeking entity device 104, partially on a providing entity device 105, and partially on a tele-dermatology system 108, or any combination thereof. In some embodiments tele-dermatology system 108 is electronically coupled with seeking entity devices 104 or providing entity devices 105 via a network 109 using a wireless connection 110 or a wired connection 111.

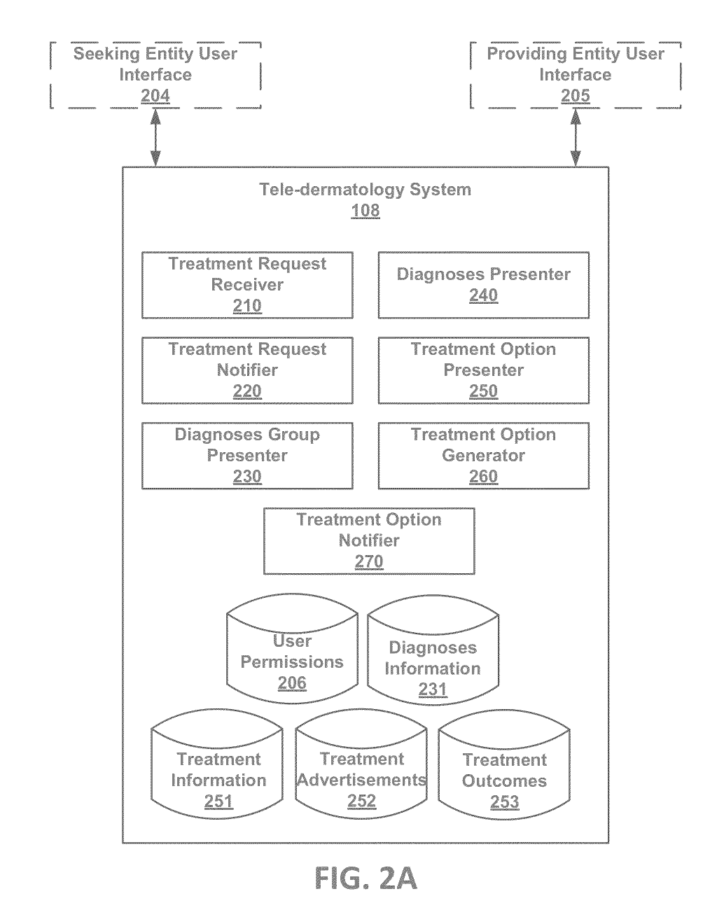

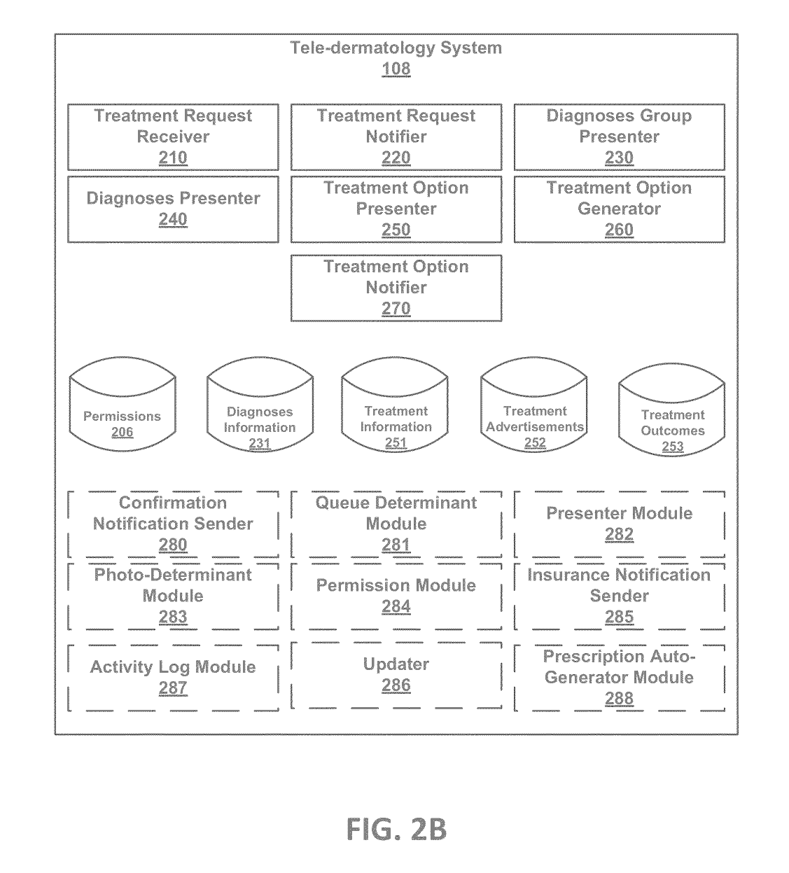

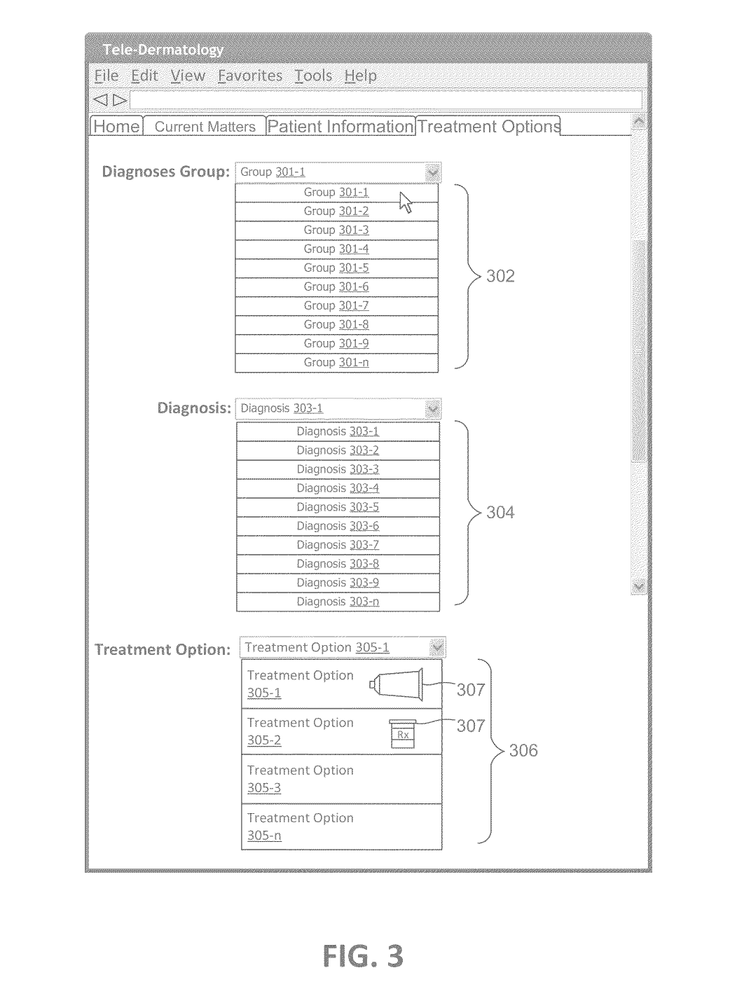

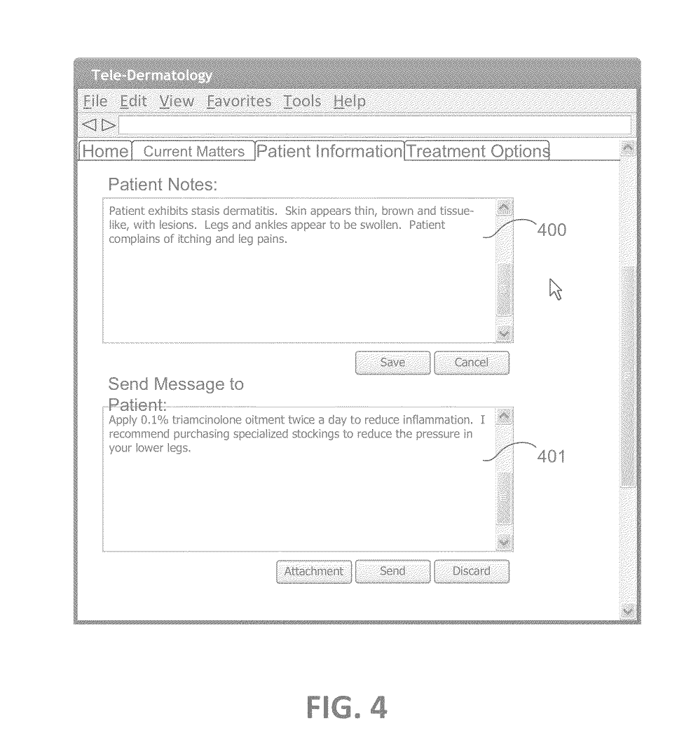

FIG. 2A illustrates an example tele-dermatology system 108. In one embodiment, tele-dermatology system 108 comprises one or more of: a treatment request receiver 210; a treatment request notifier 220; a diagnoses group presenter 230; a diagnoses presenter 240; a treatment option presenter 250; a treatment option generator 260; and a treatment option notifier 270. In some embodiments, tele-dermatology system 108 also comprises one or more of user permissions 206; diagnoses information 231; treatment information 251; treatment advertisements 252; and treatment outcomes 253. In one embodiment, a seeking entity user interface 204 is electronically coupled with tele-dermatology system 108. In one embodiment, a providing entity user interface 205 is electronically coupled with tele-dermatology system 108. As illustrated in FIG. 2B, in some embodiments, tele-dermatology system 108 additionally comprises one or more of: a confirmation notification sender 280; a queue determinant module 281; a presenter module 282; a photo-determinant module 283; a permission module 284; an insurance notification sender 285; an updater 286; an activity log module 287; and a prescription auto-generator module 288. Some components of FIGS. 2A and 2B are described with reference to FIGS. 3 and 4.

With reference to FIG. 2A, in one embodiment, treatment request receiver 210 receives a request from a seeking entity 101 seeking treatment from a providing entity 102 for a skin condition. This request may be for the seeking entity 101 themselves, or someone on their user account. In some embodiments, this may include a family member belonging to a seeking entity 101.

In one embodiment, a treatment request notifier 220 notifies a providing entity 102 of a request from a seeking entity 101. In some embodiments, a queue stores each request for each providing entity 102. In some embodiments treatment request notifier 220 notifies a providing entity 102 when providing entity 102 receives a new treatment request. In other embodiments, treatment request notifier 220 operates to remind a providing entity 102 how many treatment requests are in the queue belonging to providing entity 102. In some embodiments, treatment request notifier 220 may notify a providing entity 102 via email, text message, or other electronic communication.

In one embodiment, a diagnoses group presenter 230 presents a physician with a list of diagnoses groups. FIG. 3 illustrates one example of presentation of a list of diagnosis groups 302 which includes groups 301 (301-1 . . . 301-n). After viewing a treatment request from a seeking entity 101, a diagnoses group presenter 230 provides a providing entity 102, who is using tele-dermatology system 108, with groups of diagnoses 301-1 to 301-n to choose from while he is determining a treatment plan for the patient. In some embodiments, these groups 301 do not include diagnoses 303 themselves, but rather groups of diagnoses that are grouped into higher level categories.

In one embodiment, a diagnoses presenter 240 presents a physician with a list of diagnoses groups 302. For example, once a diagnoses group 301, such as diagnoses group 301-1 is selected by a providing entity 102, a list of diagnoses 304 which are associated with the selected diagnoses group 301 are presented to the providing entity 102 to choose from. In one embodiment, each diagnosis 303 (e.g., diagnosis 303-1 through diagnosis 303-n) is within the diagnoses group 301 (e.g., 301-1) that was selected from the list of diagnoses groups 302.

In one embodiment, a treatment option presenter 250 presents a physician with a list of treatment options 306. After a diagnosis 303 is selected, a providing entity 102 may select a treatment option 305 (e.g., one of treatment options 305-1 to 305-n), from list of treatment options 306. The selected treatment options 305 may include various medications. In one embodiment, these medications may include over-the-counter products and/or medicine available by prescription only. In one embodiment, some treatment options 305 may include no medications, but rather non-medicinal directives regarding how to treat a patient's condition. For example, in some embodiments this may include advising a patient to stay out of the sun. In other embodiments this may include advising a patient to take sitz bath.

In one embodiment, a treatment option generator 260 generates a treatment option 305 for a patient. For example, after a treatment option 305 is selected for a patient, tele-dermatology system may associate a selected treatment option 305 with the request from seeking entity 101, or with that patient's profile. Once generated, treatment option generator 260 may signal tele-dermatology system 108 to notify seeking entity 101.

In one embodiment, a treatment option notifier 270 notifies seeking entity 101 of the particular treatment option 305 selected for the patient. In some embodiments, treatment option notifier 270 sends a notification that a seeking entity 101 has completed their treatment request. In one embodiment, a seeking entity 101 will need to log in to their account with the tele-dermatology system 108 to receive their treatment option 305. In other embodiments, treatment option notifier 270 may inform a seeking entity 101 of the treatment option 305 at the same time seeking entity 101 is notified that a providing entity 102 has responded to their treatment request. A seeking entity 101 may either accept or reject the treatment option 305 proposed by the providing entity 102.

In one embodiment, user permissions 206 are implemented to permit particular users to edit diagnoses groups, diagnoses, and treatment options. In some embodiments, certain providing entities may edit diagnoses groups, diagnoses, or treatment options to conform to their preferences. For example, if a providing entity physician prefers a particular diagnoses group 301, diagnosis 303, or treatment option 305 which is not included in tele-dermatology system 108, the providing entity physician may add it so that diagnoses group presenter 230, diagnoses presenter 240, or treatment option presenter 250 presents the edited diagnoses group 301, diagnosis 303, or treatment option 305, respectively.

In one embodiment, diagnoses information 231 is stored in tele-dermatology system 108. Diagnoses information 231 may include information on each diagnosis 303 included in tele-dermatology system 108. This may include the diagnoses groups 301 a diagnosis 303 is included in, and treatment options 305 associated with diagnosis 303.

In one embodiment, treatment information 251 is stored in tele-dermatology system 108. Treatment information 251 may include detailed descriptions about each treatment option 305. This may include specific directions regarding the amount of medicine to take, directions for non-medicinal treatment options, or warnings about medicines included in the treatment option.

In one embodiment, treatment advertisements 252 are stored in tele-dermatology system 108. Treatment advertisements 252 may be for prescription medicines, over-the-counter medicines, or types of skin cream, for example. In some embodiments, as part of a treatment advertisement 252, a medication provider or other entity may request that their treatment advertisement 252 be shown at a certain location, such as the top of a treatment option list 306, when a physician is presented with treatment options 305.

In one embodiment, treatment outcomes 253 are stored in tele-dermatology system 108. Treatment outcomes 253 are entered into the tele-dermatology system 108 by seeking entity 101 for a specific treatment prescribed by a providing entity 102. Treatment outcomes 253 are entered typically after the treatment has been applied. In some embodiments, the treatment outcomes 253 can include overall impressions of treatment, time durations, treatment reactions, or other treatment related information that may be asked of seeking entity 101. In other embodiments, a providing entity 102 may enter treatment outcome 253 information into tele-dermatology system 108.

In one embodiment, a seeking entity interface user 204 provides a seeking entity 101 an interface to tele-dermatology system 108. In some embodiments seeking entity user interface 204 may be included in tele-dermatology system 108. In other embodiments, seeking entity user interface 204 may remotely communicate with tele-dermatology system 108 via one of various seeking entity devices 104, including, but not limited to: a computer 104-1; a cellular telephone 104-2; a smart phone 104-3; a portable computer 104-5; or any device which can access the internet.

In one embodiment, a providing entity user interface 205 provides a providing entity an interface to tele-dermatology system 108. In some embodiments providing entity user interface 205 may be included in tele-dermatology system 108. In other embodiments, providing entity user interface 205 may remotely communicate with tele-dermatology system 108 via one of various providing entity devices 105, including, but not limited to: including a computer 105-1; a cellular telephone 105-2; a smart phone 105-3; a portable computer 105-4; or any device which can access the internet.

FIG. 2B illustrates an embodiment of tele-dermatology system 108 including various modules which may, or may not be included in tele-dermatology system 108 depending on the particular embodiment.

In one embodiment, confirmation notification sender 280 operates to send a confirmation notification to the seeking entity 101 that the treatment request was received by a providing entity 102. This notification may be sent to one or more of various seeking entity devices 104, including, but not limited to: a computer 104-1; a cellular telephone 104-2; a smart phone 104-3; and a portable computer 104-5. In some embodiments, the notification may be sent by an automated phone call, which may be received by a voicemail box belonging to a seeking entity 101.

In one embodiment, a queue determinant module 281 operates to determine the amount of unread requests and the average time to respond in a queue belonging to a providing entity 102. Queue determinant module 281 may operate to notify a providing entity 102 when its queue reaches a certain size or report back to seeking entity 101 the average response time of providing entity 102. In one embodiment, queue determinant module 281 may operate to notify a seeking entity 101 of the average response time or size of a queue belonging to a providing entity 102, and may notify a seeking entity 101 that they can check the size of the queue or average response time from another providing entity 102.

In one embodiment, a presenter module 282 presents a seeking entity 101 with a list of other providing entities 102 that can provide a patient with a treatment. In one embodiment, presenter module 282 can analyze the average response time and/or the amount of treatment requests in queues belonging to other providing entities 102, and present a seeking entity 101 with a providing entity 102 which may have, for example, a lower average response time and/or fewer treatment requests in their treatment request queues, or an ability to handle a greater number of treatment requests.

In one embodiment, a photo-determinant module 283 operates to determine whether an image or images submitted to a providing entity 102 are of sufficient quality. If a photo of a skin condition is not of sufficient quality to be viewed by a physician, a photo-determinant module 283 may determine the quality of the image, and notify the patient if an image is not of sufficient quality. In one embodiment, photo-determinant module 283 determines whether an image is of sufficient quality shortly after the image is submitted to tele-dermatology system 108. If an image is not of sufficient quality, in some embodiments tele-dermatology system 108 notifies the seeking entity 101, and requests that the seeking entity 101 submit a new image. This saves time by not waiting for a physician to open a treatment request only to find an image of insufficient quality. In some embodiments, tele-dermatology system 108 may ask a patient for more than one image. In one embodiment, photo-determinant module 283 may perform a determination by implementing techniques which compute statistics and measurements based on the gray-level intensities of an image pixels. Photo-determinant module 283 may implement one or more of: histograms, variable illumination, vector measurement, line profiles, and intensity measurements to determine whether an image is of sufficient quality, for example.

In one embodiment, a permission module 284 operates to allow physicians to edit diagnoses groups 301, diagnoses 303, and treatment options 305. In one embodiment, permission module 284 is only available to particular physicians or system administrators. In other embodiments, permission module 284 may be available to a subset of the physicians that use tele-dermatology system 108, or to all physicians that use tele-dermatology system 108. For example, if a physician has a diagnoses group 301 he would like to create or customize, he may edit the list of diagnoses groups 302 to include a custom diagnoses group 301 which contains the diagnoses 303 he wishes to be grouped together. As another example, if a providing entity 102 wishes to add a new diagnosis 303 that is not in the system, he may do so in some embodiments. This new diagnosis 301 then can be sent to seeking entity 101 as part of the treatment for that particular treatment request. In other embodiments, when a providing entity 102 wishes to add a new diagnosis 303 a system administrator will need to approve the addition. As another example, if a providing entity 102 wishes to add a treatment option 305 not included in the list of treatment options 306 for a particular diagnosis 303, that providing entity 102 may edit the list of treatment options 306 to include a custom treatment option 305 that can be sent to seeking entity 101 as part of the treatment option 305 for that particular request. In some embodiments, permission module 284 will only allow physicians that are permitted to edit treatment options 305 to edit, add or delete treatment options 305.

In one embodiment, an insurance notification sender 285 operates to notify a patient's insurance provider that a treatment option 305 has been selected by a physician via the tele-dermatology system 108. To save a physician time, tele-dermatology system 108 may notify an insurance provider that a tele-dermatology interaction has occurred, and that the physician prescribed a particular treatment option 305. In other embodiments, insurance notification sender 285 may notify a patient's insurance provider which diagnoses 303 has been selected by a physician via tele-dermatology system 108.

In one embodiment, an updater 286 operates to update the number of treatment requests in a queue belonging to a providing entity 102. In one embodiment, after a treatment option 305 has been selected and seeking entity 101 has approved the treatment option 305, updater 286 will remove the treatment request and associated information from the queue belonging to that providing entity 102.

In one embodiment, an activity log module 287 monitors and logs all activity on a particular treatment request. This log may record and timestamp all submissions and notifications sent by either seeking entity 101 or providing entity 102 for a particular treatment request and treatment option 305. In some embodiments, the activity log module 287 is permanently stored in the tele-dermatology system 108 and cannot be edited or changed in any way by seeking entity 101, providing entity 102, or any administrator. In other embodiments, the activity log module 287 may be edited.

In one embodiment, a prescription auto-generator module 288 operates to automatically send a prescription a pharmacy of choice of seeking entity 101. In some embodiments, prescription auto-generator module 288 not only sends the prescription to a pharmacy, but also verifies that the selected pharmacy successfully received the prescription. In some embodiments, prescription auto-generator module 288 updates tele-dermatology system 108 with information that a prescription has been sent only after verification that it has been successfully sent. In one embodiment, prescription auto-generator module 288 creates an alert if verification has not been successfully sent.

### Example Tele-Dermatology System Operation

In some embodiments, the health profile of may be initially provided and entered into a database of tele-dermatology system 108 by a patient, by a primary care physician of the patient, by a worker at a health care facility through which the patient initially sought treatment, by a referring dermatologist, by an insurance company, via information exchange with an existing electronic patient record, or some combination of these or other health profile entry procedures. In some embodiments, the seeking entity 101 may choose any providing entity 102 in the system, and change providing entities 102 at any time. In some embodiments a seeking entity 101 can schedule an initial consultation, a regular visit, or a follow up electronic visit to an in-person procedure or appointment. In one embodiment, when a seeking entity 101 sends a picture and/or message, a treatment request number is created, this may also be referred to as a visit request number. In a treatment request, seeking entity 101 may include information describing the skin condition (e.g., whether it itches, previous medicines they have taken, other treatment they have attempted, whether they are pregnant, whether they are on birth control, etc.).

In one embodiment, once the providing entity 102 has viewed an image, images, videos, and/or any associated seeking entity 101 information, providing entity 102 may select a diagnoses group 301 from a list of diagnoses groups 302 provided to him. If the image is not of sufficient quality, or if more information from seeking entity 101 is required before treatment, providing entity 102 may send seeking entity 101 a notification indicating that seeking entity 101 will need to supply an image of sufficient quality or provide additional information to facilitate treatment.

Referring again to FIG. 3, in one embodiment, each diagnoses group 301 corresponds with a list of diagnoses 304. In some embodiments, the diagnoses groups 301 may be presented in various formats, such as a drop down menu or a table. After a diagnoses group 301 is selected, a physician is provided with a list of diagnoses 304 that corresponds to the selected diagnoses group 301. The providing entity 102 then may choose a diagnosis 303 from within the list of diagnoses 304. In some embodiments, once a physician has chosen a diagnosis, he is presented with a list of treatment options 306 for that diagnosis. Each treatment option 305 may comprise medication, physical therapy, or surgery, for example. It should be noted that in FIG. 3, for purposes of clarity drop down menus are presented as fully extended, but would in some embodiments become collapsed after selection from each drop down menu. It is further appreciated that other presentation mechanisms may be utilized in addition to or as an alternative to drop down menus. For example, some or all selections illustrated in FIG. 3 as selectable items from a drop down menu may be illustrated as an array of selectable boxes, in some embodiments.

In some embodiments, the medications within various treatment options 305 may be advertisements 252 sponsored by a third party. In some embodiments, for example physical therapists, pharmaceutical companies, cosmetic product companies, and/or surgeons may sponsor advertisements 252 to be included in the list of treatment options 306. Advertisements 252 may be displayed in various ways. For example, in some embodiments treatment option 305 will give no indication that it is an advertisement. In some embodiments, an advertisement indicator 307 will be associated with a treatment option 305. In one embodiment, advertisement indicator 307 may be an image of a particular medication placed in close proximity to the treatment option 305 associated with the advertisement 252. In other embodiments advertisement 252 may not be located near treatment option 305. In other embodiments, the advertisement indicator 307 may take the form of text, rather than an image. Additionally or alternatively, an advertisement 252 may be displayed in a certain location within a list of treatment options 306. Some examples, of presented location include: first, within the top two, within the top three, etc.

Referring now to FIG. 4, in one embodiment, once a treatment option 305 is selected, providing entity 102 may send a message to seeking entity 101, prepare a prescription to be automatically sent later, or in real time, to a pharmacy after seeking entity 101 accepts treatment. In some embodiments a prescription will not be sent to a pharmacy until providing entity 102 deliberately sends the prescription to a pharmacy.

In addition to prescribing a treatment option 305 for the seeking entity 101, the providing entity 102 may also write personal notes 400 and associate them with a treatment request number of seeking entity 101. In some embodiments, these notes 400 are available only to the particular providing entity 102 but may also be shared (by the providing entity 102 that created the notes) with other providing entities 102 in order to provide them with a more complete description of seeking entity 101, their history, and their proclivities. In other embodiments these notes 400 are available to seeking entity 101, providing entity 102, or both.

In some embodiments, a message box 401 allows a providing entity 102 to send a message to a seeking entity 101. In some embodiments, message box 401 is used to send a seeking entity 101 a message along with their treatment option 305. In other embodiments, message box 401 is used to send a seeking entity 101 follow-up messages. It is appreciated that someone skilled in the art would recognize that message box 401 can be used to send images, multimedia, or messages including information other than treatment options 305 and for purposes other than follow-up messages.

After a diagnosis 303 and treatment option 305 are chosen, tele-dermatology system 108 sends the diagnosis and treatment option back to the seeking entity 101 through tele-dermatology system 108. In some embodiments, seeking entity 101 may be prompted to accept or refuse treatment option 305. In one embodiment, providing entity 102 may enter an electronic signature or other authorization to confirm a treatment option 305 and/or a pharmacological prescription. In some embodiments, tele-dermatology system 108 will also send a message containing a prescription to a pharmacy near seeking entity 101. In other embodiments, the pharmacy may be selected through tele-dermatology system 108 by the seeking entity 101. In some embodiments, the seeking entity 101 may refuse the treatment option 305, and reply as such to providing entity 102. An electronic signature or other confirmation from the seeking entity 101 may be included in a refusal of a treatment option. In some embodiments, the tele-dermatology system 108 may also send appropriate insurance billing codes and billing information on behalf of the providing entity 102 to an insurance provider specified by the seeking entity 101.

### Dermatologic Treatment

Dermatology is the branch of medicine dealing with the skin and its diseases. Like many medical specializations, dermatology involves both medical and surgical aspects. However, unlike many medical specializations, a dermatologist may diagnose a patient without being in the physical presence of the patient. Skin diseases can readily be diagnosed by sight without any physical manipulation by the physician. This provides dermatologists with the ability to diagnose skin conditions from at least one image of a patient's skin and associated patient (seeking entity 101) information.

If a skin disease can be cured without surgery, a physician may prescribe medication and treatment options which do not require a patient to be physically present. For example, skin diseases such as folliculitis, dermatitis and keratosis may be cured by antibiotics and reduced sun exposure. In such a case a physician may prescribe the medication by calling the patient's pharmacy or by electronic message.

### Dermatologic Diagnoses

In order to lessen the time a physician may spend searching for a diagnosis, various diagnoses are separated into diagnoses groups 301. Each diagnoses group 301 has a common feature, such as type of disease, for example. Within each diagnoses group 301 are individual diagnoses 303.

In some embodiments, diagnoses groups 301 are separated by type of disease. Diagnoses groups 301 include, but are not limited to: acne, folliculitis, dermatitis, nevi, cysts, psoriasis, skin cancer, tinea, nails, pigment abnormalities, photosensitivity, solar changes, lichen, infections, infestations, vascular, benign neoplasia, and genital.

Individual diagnoses 303, which may be found in the diagnoses groups 301, include, but are not limited to: acne, comedonal acne, folliculitis, furuncle, hidradenitis suppurativa, nodular cystic acne, perioral dermatitis, rosacea, allergic contact dermatitis, atopic dermatitis, eczema, foot eczema, intertrigo, irritant contact dermatitis, nummular dermatitis, seborrheic dermatitis, stasis dermatitis, congenital nevus, melanocytic nevus, probable melanocytic nevus but cannot rule out skin cancer, epidermal nevus, nevus sebaceous, nevus spilus, spitz nevus, seborrheic keratosis, probable seborrheic keratosis but cannot rule out skin cancer, inflamed seborrheic keratosis, probable inflamed seborrheic keratosis but cannot rule out skin cancer, actinic keratosis, probable actinic keratosis but cannot rule out skin cancer, hypertrophic actinic keratosis, lichenoid keratosis, disseminated superficial actinic porokeratosis, alopecia areata, apthous ulcer, arthropod bite, Dupuytren's contracture, erythema multiforme, drug eruption, granuloma annulare, hidrocystoma, keratoderma, morphea, pemphigoid, perleche, pityriasis rosea, prurigo nodularis, stasis ulcer, Stevens Johnson syndrome, striae, transient acantholytic dermatosis (Grover's), urticarial, viral exanthema, xanthelasma palpebrum, xanthogranuloma, xerosis, epidermoid cyst, milium cyst, pilar cyst, ruptured epidermoid cyst/abcess, synovial cyst, guttate psoriasis, inverse psoriasis, psoriasis, pustular psoriasis, basal cell carcinoma, squamous cell carcinoma in situ, squamous cell carcinoma, malignant melanoma in situ, malignant melanoma, onychomycoses, tinea capitus, tinea corporis, tinea cruris, tinea pedis, tinea unguium, tinea versicolor, habit tic deformity, lichen planus, median nail dystrophy, onychomycosis, paronychia, photoonycholysis, pseudomonas infection, psoriasis, traumatic onycholysis, café au lait patch, melisma, pigmented purpuric dermatosis, pityriasis alba, post inflammatory hyperpigmentation, post inflammatory hypopigmentation, solar purpura, vitiligo, drug induced photosensitivity, phytophotodermatitis, poikiloderma of Civatte, polymorphous light eruption, solar purpura, solar urticarial, lichen aureus, lichen nitidus, lichen planus, lichen sclerosis et atrophicus, lichen simplex chronicus, lichen striatus, cellulitis, flat wart, genital or venereal wart, herpes simplex type I, herpes simplex type II, impetigo, insect bite reaction, lyme disease/erythema migrans, molluscum contagiousum, pediculosis capitus, pediculosis pubis, scabies, shingles/varicella zoster, wart, arterial venous malformation, cherry angioma, hemangioma, port wine stain, spider angioma, telangiectasia, venous lake, dermatofibroma, disseminated superficial actinic porokeratosis, hidrocystoma, neurofibroma, pearly penile papules, sebaceous hyperplasia, skin tag, candidiasis, contact dermatitis, folliculitis, herpes simplex type II, hidradenitis suppurativa, intertrigo, lichen planus, lichen sclerosis et atrophicus, molluscum contagiosum, pediculosis pubis, primary syphilis, pruritus ani, pruritus vulvi, psoriasis, squamous cell carcinoma, tinea cruris, venereal warts, or Zoon's balanitis.

### Dermatologic Treatment Options

Each diagnosis has an associated list of treatment options 306. As discussed above, once a providing entity selects a diagnosis 303, tele-dermatology system 108 will present the providing entity 102 with a list of treatment options 306. In some embodiments, the treatment options 305 may include various medications. These medications may be available by prescription only, over-the-counter, or a combination of the two. In some embodiments, treatment options 305 may include no medicine at all, but instead instructions including, but not limited to: staying out of the sun, refraining from swimming, etc.

Prescription medications include, but are not limited to: minocycline, acyclovir, betamethasone dipropionate, betamethasone valerate, calcipotriene, cephalexin, clindamycin, clobetasol, dicloxacillin, doxepin, doxycycline, erythromycin, famciclovir, hydroxyzine, hydrocortisone, hydroquinone, ketoconazole, selenium sulfide, terbinafine, tetracycline, tretinoin, triamcinolone, valacyclovir, clindamycin, benzoyl peroxide gel, dapsone gel, calcipotriene ointment, clobetasol spray, adapalene lotion, aluminum chloride hexahydrate, fluorouracil, adalimumab, betamethasone valerate foam, metronidazole, clobetasol foam, tretinoin cream, tretinoin gel, ustekinumab, calcitriol ointment, sinecatechins, acyclovir, hydrocortisone, imiquimod cream, sertaconazole nitrate, naftifine, calcipotriene, etamethasone dipropionate, adapalene, benzoyl peroxide, valacyclovir, or terbinafine.

Over-the-counter medications include, but are not limited to: sunscreens, moisturizers, soap and cleansers, acne medications, antifungals, anti-itch medications, poison oak medications, artificial tanners, shampoos, deodorants, make-up, hair color, wart care medications, insect repellents, skin bleaching products, psoriasis medication, lice treatments, shaving creams, antihistamines, diaper rash treatments, hair removal products, or hair regrowth products.

### Example Computer System Environment

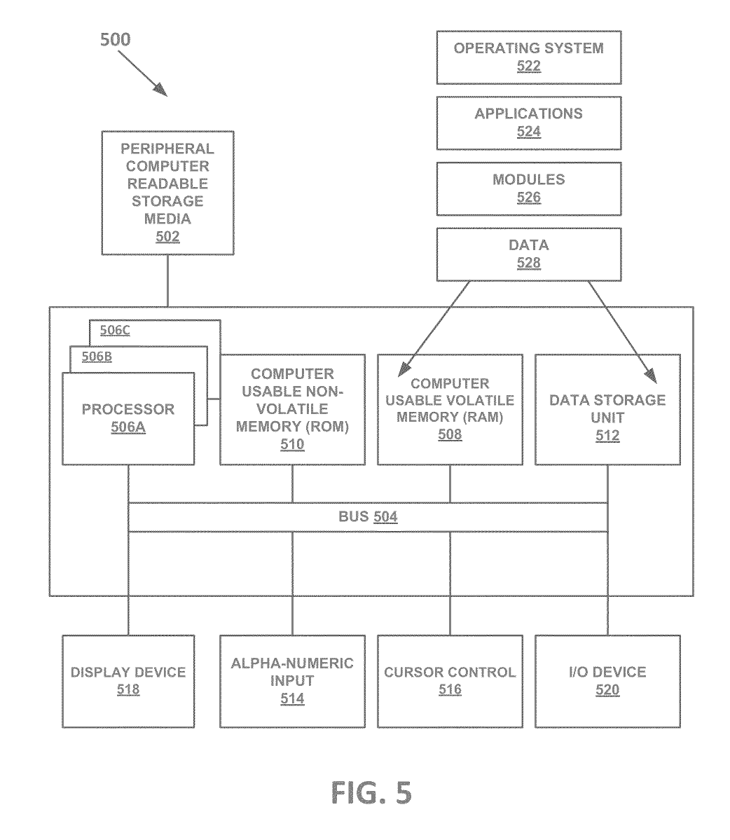

With reference now to FIG. 5, all or portions of some embodiments described herein are composed of computer-readable and computer-executable instructions that reside, for example, in computer-usable/computer-readable storage media of a computer system. That is, FIG. 5 illustrates one example of a type of computer (computer system 500) that can be used in accordance with or to implement various embodiments which are discussed herein. It is appreciated that computer system 500 of FIG. 5 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, and the like. Computer system 500 of FIG. 5 is well adapted to having peripheral tangible computer-readable storage media 502 such as, for example, a floppy disk, a compact disc, digital versatile disc, other disc based storage, universal serial bus “thumb” drive, removable memory card, and the like coupled thereto. The tangible computer-readable storage media is non-transitory in nature.

System 500 of FIG. 5 includes an address/data bus 504 for communicating information, and a processor 506A coupled with bus 504 for processing information and instructions. As depicted in FIG. 5, system 500 is also well suited to a multi-processor environment in which a plurality of processors 506A, 506B, and 506B are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g., random access memory (RAM), coupled with bus 504 for storing information and instructions for processors 506A, 506B, and 506C. System 500 also includes computer usable non-volatile memory 510, e.g., read only memory (ROM), coupled with bus 504 for storing static information and instructions for processors 506A, 506B, and 506C. Also present in system 500 is a data storage unit 512 (e.g., a magnetic or optical disk and disk drive) coupled with bus 504 for storing information and instructions. System 500 also includes an optional alphanumeric input device 514 including alphanumeric and function keys coupled with bus 504 for communicating information and command selections to processor 506A or processors 506A, 506B, and 506C. System 500 also includes an optional cursor control device 516 coupled with bus 504 for communicating user input information and command selections to processor 506A or processors 506A, 506B, and 506C. In one embodiment, system 500 also includes an optional display device 518 coupled with bus 504 for displaying information.

Referring still to FIG. 5, optional display device 518 of FIG. 5 may be a liquid crystal device, cathode ray tube, plasma display device or other display device suitable for creating graphic images and alphanumeric characters recognizable to a user. Optional cursor control device 516 allows the computer user to dynamically signal the movement of a visible symbol (cursor) on a display screen of display device 518 and indicate user selections of selectable items displayed on display device 518. Many implementations of cursor control device˜516 are known in the art including a trackball, mouse, touch pad, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet.

Referring still to FIG. 5, various other components are depicted for system 500. Specifically, when present, an operating system 522, applications 524, modules 526, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer-readable storage media.

### Example Methods of Use

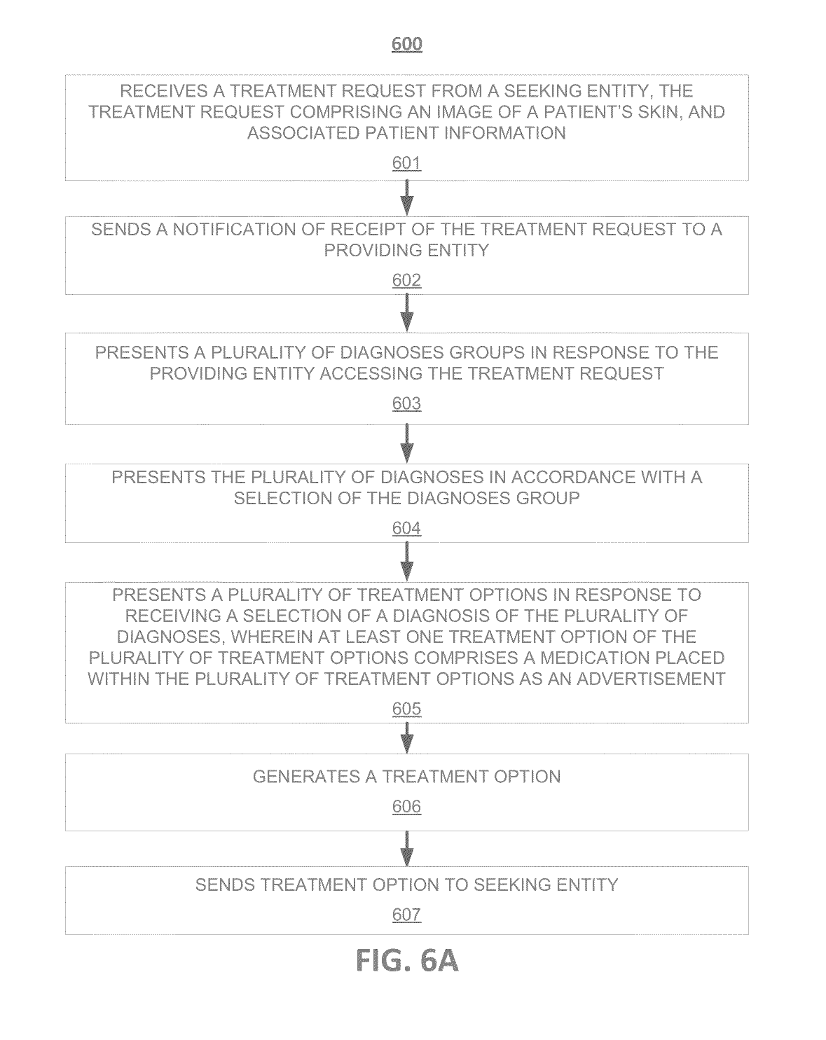

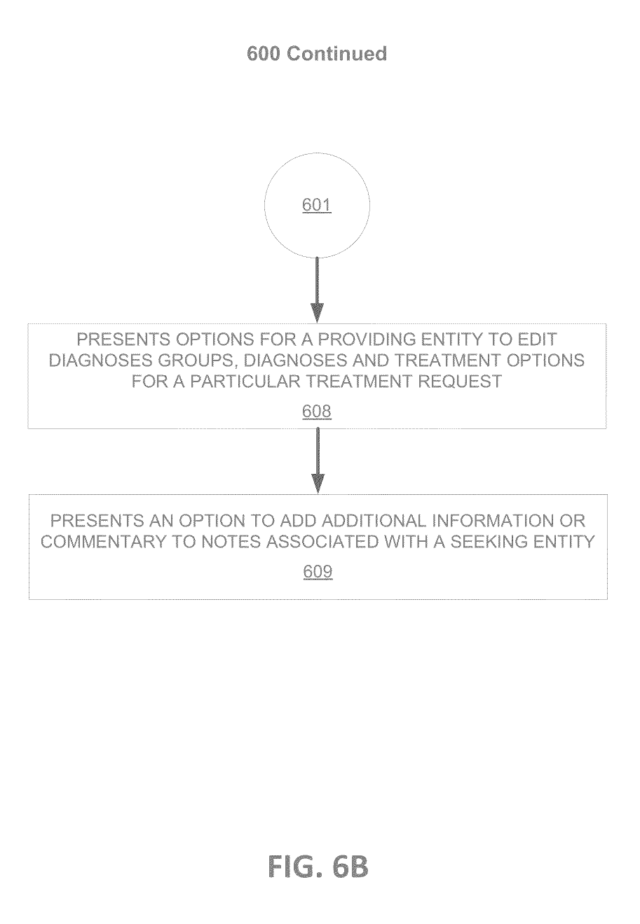

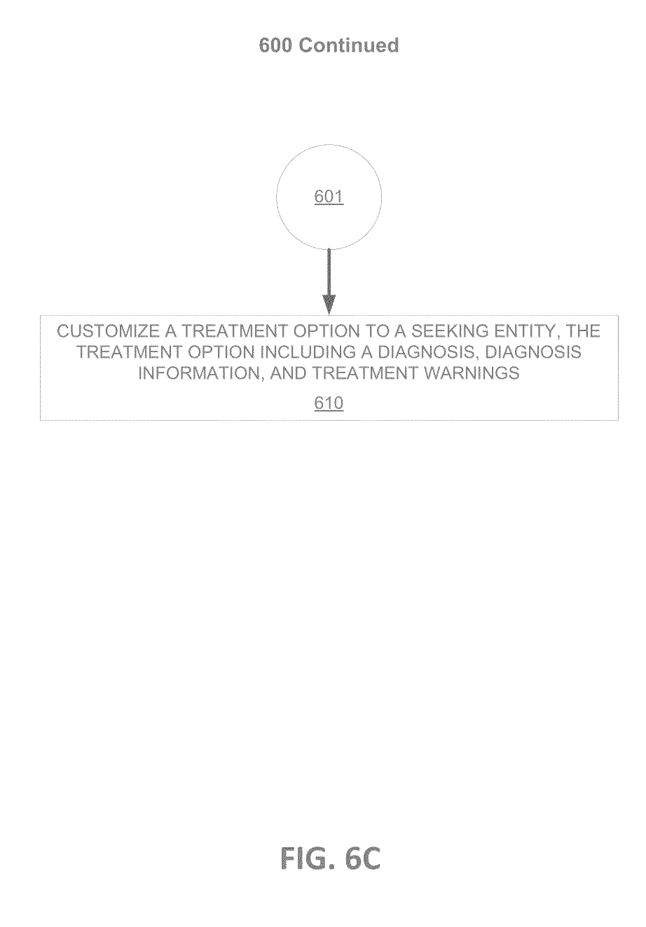

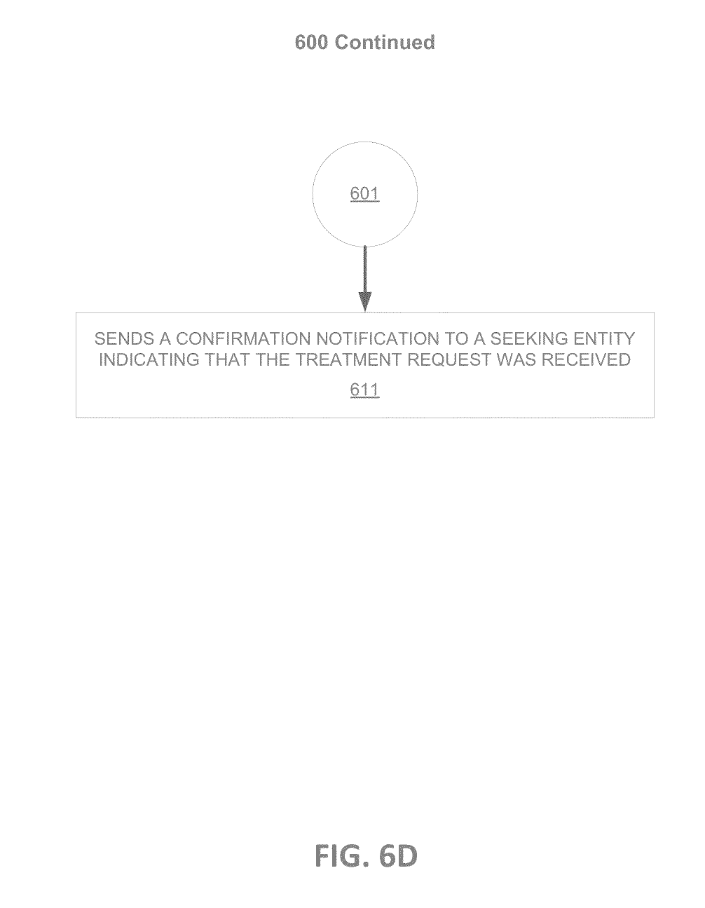

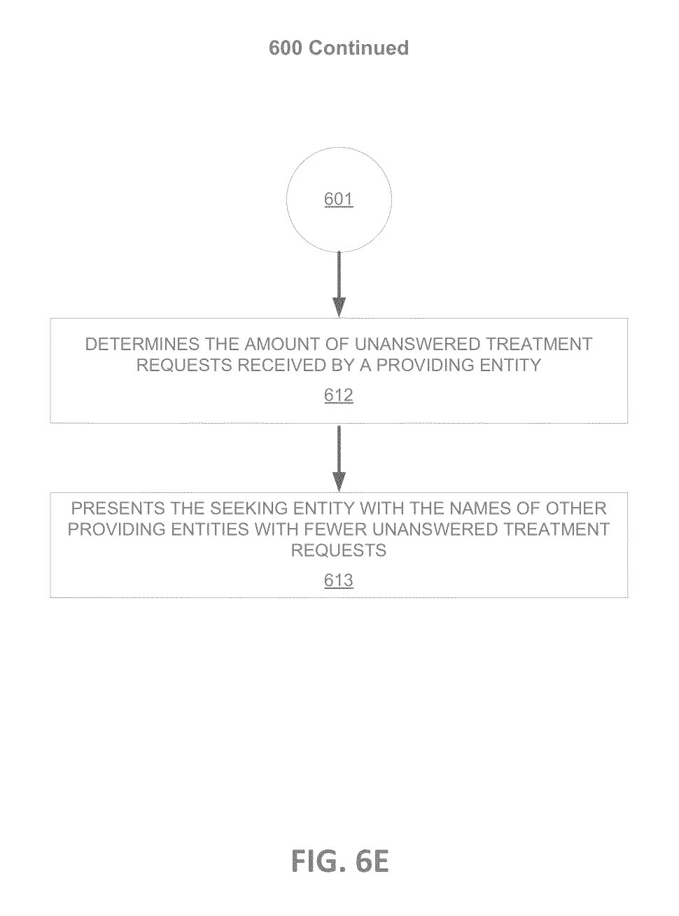

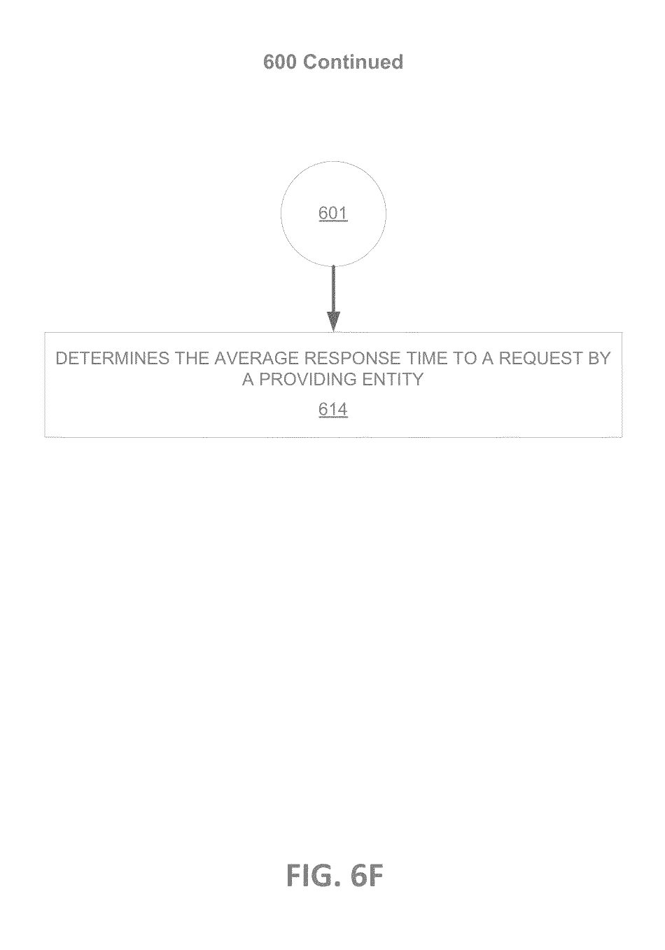

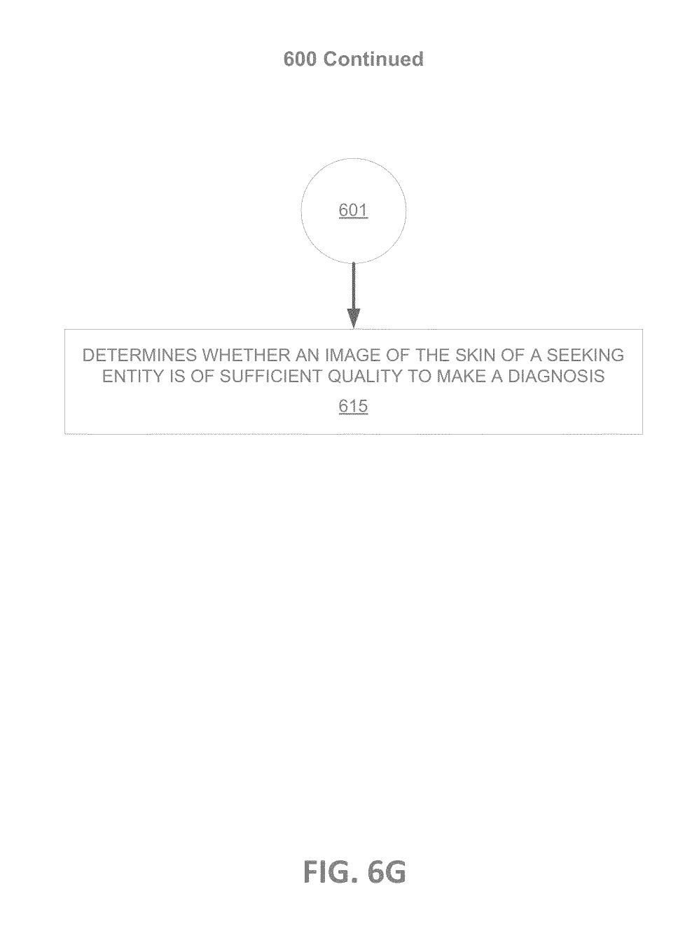

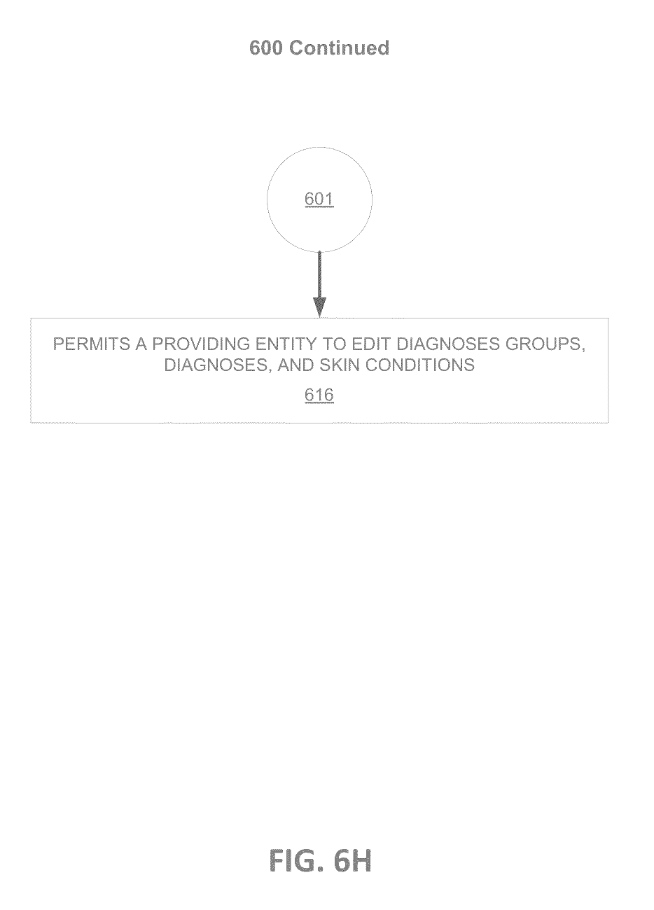

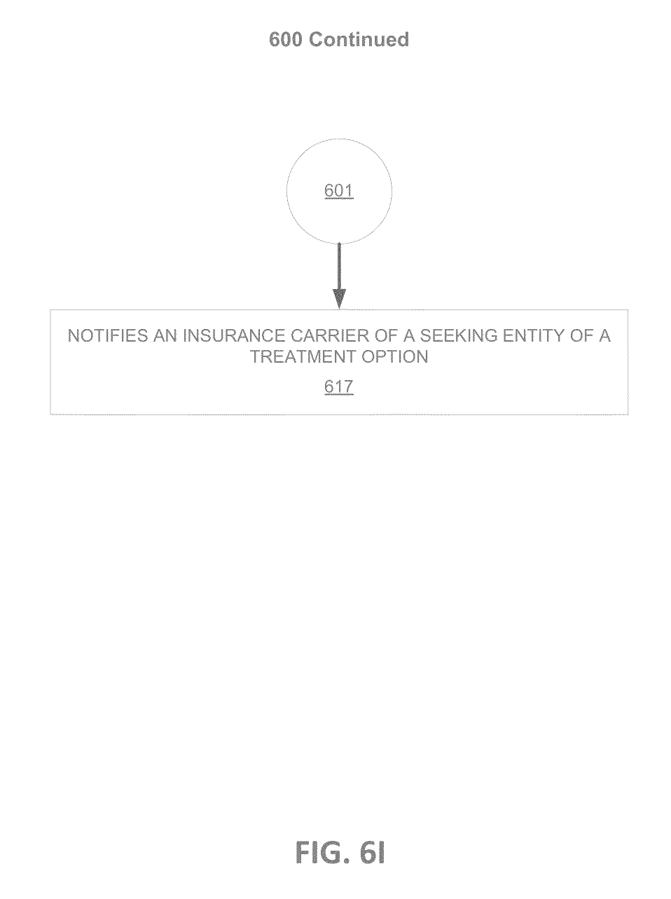

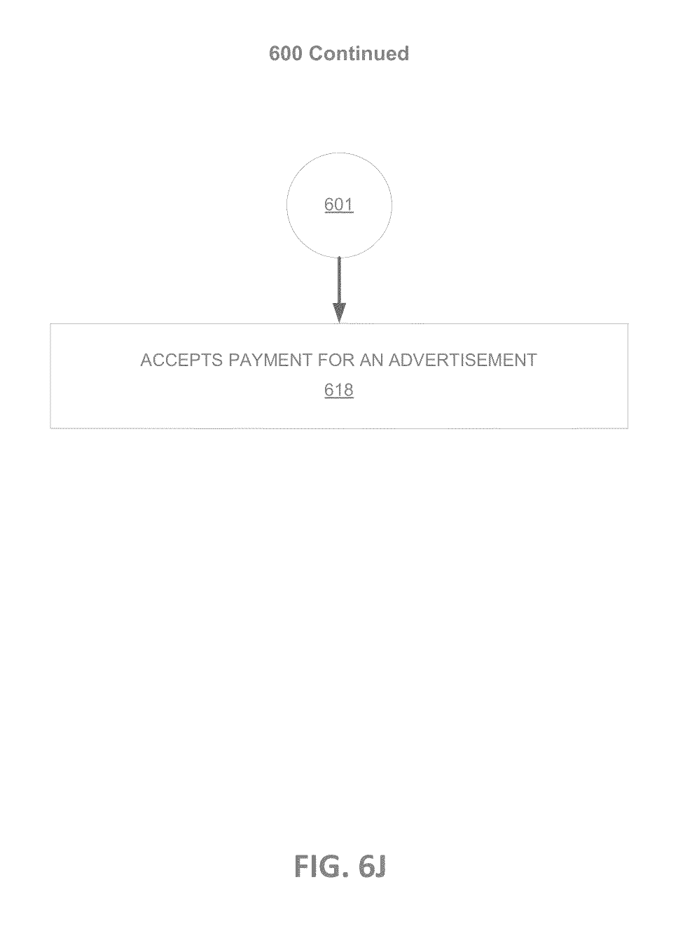

The following discussion sets forth in detail the operation of some example methods of operation of embodiments. With reference to FIGS. 6A-6J and flow diagram 600 illustrate example procedures used by various embodiments. Flow diagram 600 includes some procedures that, in various embodiments, are carried out by a processor under the control of computer-readable and computer-executable instructions. In this fashion, procedures described herein and in conjunction with flow diagram 600 are or may be implemented using a computer, in various embodiments. The computer-readable and computer-executable instructions can reside in any tangible computer readable storage media, such as, for example, in data storage features such as RAM 508, ROM 510, and/or storage device 512 (all of FIG. 5). The computer-readable and computer-executable instructions, which reside on tangible computer readable storage media, are used to control or operate in conjunction with, for example, one or some combination of processor 506A, or other similar processor(s) 506B and 506C. Although specific procedures are disclosed in flow diagram 600, such procedures are examples. That is, embodiments are well suited to performing various other procedures or variations of the procedures recited in flow diagram 600. Likewise, in some embodiments, the procedures in flow diagram 600 may be performed in an order different than presented and/or not all of the procedures described in one or more of these flow diagrams may be performed. It is further appreciated that procedures described in flow diagram 600 may be implemented in hardware, or a combination of hardware, with either or both of firmware and software.

With reference to FIGS. 6A-6J, flow diagram 600 illustrates example procedures used by various embodiments. Flow diagram 600 includes process and operations that, in various embodiments, are carried out by one or more of the electronic devices illustrated in FIG. 1, FIG. 2A-2B, or via a computer system 500.

Although specific procedures are disclosed in flow diagram 600, such procedures are examples. That is, embodiments are well suited to performing various other operations or variations of the operations recited in the process of flow diagram 600. Likewise, in some embodiments, the operations in flow diagram 600 may be performed in an order different than presented, not all of the operations described in one or more of these flow drawings may be performed, and/or one or more additional operations may be added.

FIG. 6A is a flow diagram 600 of an example method of providing dermatologic treatment. Reference will be made to FIGS. 1-5 to facilitate the explanation of the operations of the method of flow diagram 600. In one embodiment, the method of flow diagram 600 describes the communication between seeking entity 101 and providing entity 102.

At operation 601, in one embodiment, tele-dermatology system 108 receives a treatment request from seeking entity 101. The treatment request comprises at least one image of skin and associated seeking entity 101 information sent by seeking entity 101. The treatment request is associated with the patient information of seeking entity 101. The treatment request may be sent electronically, which includes, but is not limited to: email, instant message, facsimile, SMS, MMS, telephony, telegraph, video messaging, and cloud-based messaging. All messages mentioned herein may be sent and/or received by devices including, but not limited to: smart phones; personal digital assistants; personal computers; or other devices capable of accessing the internet. In some embodiments, the treatment request is received by treatment request receiver 201, which may be implemented by a computer system such as computer system 500. In some embodiments, for example, once tele-dermatology system 108 receives a request for treatment from a seeking entity 101 via I/O device 520, computer system 500 located within tele-dermatology system 108 will process the request and store the request non-volatile memory 510, volatile memory 508, peripheral storage media 502, and/or data storage unit 512, for example.

At operation 602, in one embodiment, tele-dermatology system 108 sends seeking entity 101 a notification of receipt. In some embodiments, the notification of receipt is sent by treatment request notifier 220, which may be implemented by a computer system such as computer system 500. In some embodiments, for example, tele-dermatology system 108 sends a notification of receipt via I/O device 520. In one embodiment, I/O device 520 may include, but is not limited to: an Ethernet card, a wireless receiver/transmitter, or a modem.

At operation 603, in one embodiment, tele-dermatology system 108 presents a physician with a list of diagnoses groups 302 in response to a physician accessing the treatment request of seeking entity 101. In some embodiments, the list of diagnoses groups 302 is presented by diagnoses group presenter 230, which may be implemented by a computer system such as computer system 500. The presented diagnoses groups 301 are comprised of a plurality of diagnoses 303 that are grouped together. In some embodiments, computer system 500 stores the various diagnoses groups 301 and their corresponding diagnoses 303 in storage media 502, 510, 508, and/or 512.

At operation 604, in one embodiment, tele-dermatology system 108 presents providing entity 102 with a list of diagnoses 304 contained corresponding to the chosen diagnoses group 301. In some embodiments, the list of diagnoses 304 is presented by diagnoses presenter 240, which may be implemented by a computer system such as computer system 500. A physician may then select a diagnosis. In some embodiments, computer system 500 stores the various diagnoses groups 301 and their corresponding diagnoses 303 in storage media 502, 510, 508, and/or 512.

At operation 605, in one embodiment, tele-dermatology system 108 presents a list of treatment options 306 in response to receiving a selection from a providing entity 102. In some embodiments, the list of treatment options 306 is presented by treatment option presenter 250, which may be implemented by a computer system such as computer system 500. At least one of the treatment options 305 provided by tele-dermatology system 108 comprises a medication placed within the list of treatment options 306 as an advertisement. In some embodiments the treatment option 305 that comprises an advertisement may be near the top of the list of treatment options 306, or it may be near the bottom of the list of treatment options 306. In some embodiments, computer system 500 is configured to present advertisements 252 in a particular order. For example, the configuration may correspond to the amount of money the advertiser pays.

At operation 606, in one embodiment, tele-dermatology system 108 generates a treatment option 305. The generation of treatment option 305 may be in response to receiving a selection of at least one diagnosis 303. In some embodiments, the treatment options 305 are generated by treatment option generator 260, which may be implemented with a computer system such as computer system 500. In some embodiments the treatment options 305 are generated by the tele-dermatology system 108. In other embodiments the treatment options may be edited by providing entity 102.

At operation 607, in one embodiment, tele-dermatology system 108 sends the treatment option 305 chosen by providing entity 102 to seeking entity 101. In some embodiments, the treatment option 305 is sent to seeking entity 101 by treatment option notifier 270, which may be implemented by a computer system such as computer system 500. The treatment option 305 may be sent electronically via I/O device 520, which includes, but is not limited to: email, instant message, facsimile, SMS, MMS, telephony, telegraph, video messaging, and cloud-based messaging. In some embodiments, seeking entity 101 may refuse the particular treatment option 305. Seeking entity 101 may provide feedback as to why seeking entity 101 refused the particular treatment option 305.

With reference to FIG. 6B, at operation 608, in one embodiment, tele-dermatology system 108 presents options for providing entity 102 to edit diagnoses groups 301, diagnoses 303, and treatment options 305. Providing entity 102 may edit these elements based, at least in part on a particular treatment request.

At operation 609, in one embodiment, tele-dermatology system 108 presents providing entity 102 with an option to add additional information or commentary to notes 400 associated with seeking entity 101. In some embodiments notes 400 may be available to seeking entity 101. In other embodiments, notes 400 may only be available to providing entity 102. Providing entity 102 may further share notes 400 with others.

With reference to FIG. 6C, at operation 610, in one embodiment, tele-dermatology system 108 may customize a treatment option 305 for seeking entity 101. In one embodiment, treatment option 305 may include a diagnosis 303, diagnosis information, and treatment options 305. In some embodiments, providing entity 102 may customize treatment option 305.

With reference to FIG. 6D, at operation 611, in some embodiments, tele-dermatology system 108 sends a confirmation notification to seeking entity 101 indicating that a treatment request was received. As discussed herein, this notification may be sent via I/O device 520, which includes, but is not limited to: email, instant message, facsimile, SMS, MMS, telephony, telegraph, video messaging, and cloud-based messaging.

With reference to FIG. 6E, at operation 612, in some embodiments, tele-dermatology system 108 determines the amount of unanswered treatment requests received by providing entity 102. In some embodiments, computer system 500 may perform this determination.

At operation 613, in some embodiments, tele-dermatology system 108 presents seeking entity 101 with the names of other providing entities 102 with fewer unanswered treatment requests. In some embodiments tele-dermatology system 108 allows seeking entity 101 to transfer their treatment request to another providing entity 102 without having to reenter their information or re-upload an image or video of their skin.

With reference to FIG. 6F, at operation 614, in some embodiments, tele-dermatology system 108 determines the average response time to a request by a providing entity 102. In some embodiments, computer system 500 may perform this determination.

With reference to FIG. 6G, at operation 615, in some embodiments, tele-dermatology system 108 determines whether an image of the skin or associated information of seeking entity 101 is of sufficient quality to make a diagnosis. It should be understood that the skin in the image or associated information may belong to someone other than seeking entity 101, such as a family member of seeking entity 101, for example. In some embodiments, the quality of the image of the skin is determined by photo-determinant module 283, which may be implemented by a computer system such as computer system 500. Quality determination techniques may include, but are not limited to: histograms, variable illumination, vector measurement, line profiles, and intensity measurements. Additionally, in some embodiments, tele-dermatology system 108 may alert a seeking entity 101 if an image was not uploaded or failed to upload correctly.

With reference to FIG. 6H, at operation 616, in some embodiments, tele-dermatology system 108 permits a providing entity 102 to edit diagnoses groups 301, diagnoses 303, and various skin conditions.

With reference to FIG. 6I, at operation 617, in some embodiments, tele-dermatology system 108 notifies the insurance carrier of a seeking entity 101 of a treatment option 305 provided by providing entity 102. Insurance carriers may use this information for their records.

With reference to FIG. 6J, at operation 618, in some embodiments, tele-dermatology system 108 accepts payment for an advertisement. It should be understood that advertisements may be ordered by firms including, but not limited to: pharmaceutical companies, cosmetic firms, physicians, medical device firms, etc.

Example embodiments of the subject matter are thus described. Although various embodiments of the subject matter have been described in a language specific to structural features and/or methodological acts, it is to be understood that the appended claims are not necessarily limited to the specific features or acts described above. Rather, the specific features and acts described above are disclosed as example forms of implementing the claims and their equivalents.

What is claimed is:

1. A method for providing dermatologic treatment, said method comprising:
receiving a treatment request from a seeking entity, said treatment request comprising an image of a skin of a patient, said treatment request associated with patient information of said patient;
sending a notification of receipt of said treatment request to a providing entity, wherein said providing entity is a dermatologist;
presenting a plurality of diagnoses groups in response to said providing entity accessing said treatment request, wherein a diagnosis group of said diagnoses groups comprises a plurality of diagnoses that are grouped together according to types of skin conditions;
presenting said plurality of diagnoses in accordance with a selection of said diagnoses group;
presenting a plurality of treatment options in response to receiving a selection of a diagnosis of said plurality of diagnoses, wherein at least one treatment option of said plurality of treatment options comprises a medication placed within said plurality of treatment options as an advertisement;
generating a treatment option; and
sending said treatment option to said seeking entity.

2. The method of claim 1 further comprising:
presenting options for said providing entity to edit diagnoses groups, diagnoses, and treatment options for a particular treatment request; and
presenting an option to add additional information to notes associated with said seeking entity, wherein said option is only available to said seeking entity.

3. The method of claim 1 further comprising:
customizing said treatment option to said seeking entity, said treatment option including a diagnosis, diagnosis information, and treatment warnings.

4. The method of claim 1 wherein said option further includes providing entity information.

5. The method of claim 1 further comprising:
sending a confirmation notification to said seeking entity that said treatment request was received.

6. The method of claim 1 further comprising:
determining an amount of unanswered treatment requests received by said providing entity; and
presenting said seeking entity with a plurality of names of other providing entities with fewer unanswered treatment requests.

7. The method of claim 6 further comprising:
determining an average response time to a request by said providing entity.

8. The method of claim 1 further comprising:
determining whether said image of the skin of said seeking entity is of sufficient quality to make a diagnosis.

9. The method of claim 1 further comprising:
permitting said providing entity to edit said diagnoses groups, said diagnoses, and said types of skin conditions.

10. The method of claim 1 further comprising:
notifying an insurance carrier of said seeking entity of said treatment option.

11. The method of claim 1, further comprising:
accepting payment for said advertisement.

12. A non-transitory computer readable storage medium having computer readable instructions stored thereon which, when executed, causes a computer system to perform a method for providing dermatologic treatment, said method comprising:
receiving a treatment request from a seeking entity, said treatment request comprising an image of a skin of a patient, said treatment request associated with patient information of said patient;
sending a notification of receipt of said treatment request to a providing entity, wherein said providing entity is a dermatologist;
presenting a plurality of diagnoses groups in response to said providing entity accessing said treatment request, wherein a diagnosis group of said diagnoses groups comprises a plurality of diagnoses that are grouped together according to types of skin conditions;
presenting said plurality of diagnoses in accordance with a selection of said diagnoses group;
presenting a plurality of treatment options in response to receiving a selection of a diagnosis of said plurality of diagnoses, wherein at least one treatment option of said plurality of treatment options comprises a medication placed within said plurality of treatment options as an advertisement;
generating a treatment option; and
sending said treatment option to said seeking entity.

13. The non-transitory computer readable storage medium of claim 12, wherein the method further comprises:
sending a confirmation notification to said patient that said treatment request was received.

14. The non-transitory computer readable storage medium of claim 12, wherein the method further comprises:
determining an amount of unanswered treatment requests received by said providing entity; and
presenting said patient with a plurality of names of other providing entities with fewer unanswered treatment requests.

15. The non-transitory computer readable storage medium of claim 12, wherein the method further comprises:
determining whether said image of said patient's skin is of sufficient quality to make a diagnosis.

16. The non-transitory computer readable storage medium of claim 12, wherein the method further comprises:
notifying an insurance carrier belonging to said patient of said treatment option.

17. A system comprising:
a memory for storing permissions to access content associated with a user;
at least one data processing apparatus operable to interact with the memory and to perform operations comprising:
receiving a treatment request from a seeking entity, said treatment request comprising an image of a patient's skin, said treatment request associated with patient information of said patient;
sending a notification of receipt of said treatment request to a providing entity, wherein said providing entity is a dermatologist;
presenting a plurality of diagnoses groups in response to said providing entity accessing said treatment request, wherein a diagnosis group of said diagnoses groups comprises a plurality of diagnoses that are grouped together according to types of skin conditions;
presenting said plurality of diagnoses in accordance with a selection of said diagnoses group;
presenting a plurality of treatment options in response to receiving a selection of a diagnosis of said plurality of diagnoses, wherein at least one treatment option of said plurality of treatment options comprises a medication placed within said plurality of treatment options as an advertisement;
generating a treatment option; and
sending said treatment option to said patient.

18. The system of claim 17, wherein the system further comprises:
a confirmation notification sender that sends a confirmation notification to said seeking entity that said treatment request was received.

19. The system of claim 17, wherein the system further comprises:
a queue-determinant module that determines an amount of unanswered treatment requests received by said providing entity; and
a presenter module that presents said patient with a plurality of names of other providing entities with fewer unanswered treatment requests.

20. The system of claim 17, wherein the system further comprises:
a photo-determinant module that determines whether said image of said patient's skin is of sufficient quality to make a diagnosis.
